(19) United States
(12) Patent Application Publication
(10) Pub. No.: US 2011/0179636 A1
(43) Pub. Date: Jul. 28, 2011

(54) INTERCALATION ANODE PROTECTION FOR CELLS WITH DISSOLVED LITHIUM POLYSULFIDES

(75) Inventors: Lutgard C. De Jonghe, Lafayette, CA (US); Yevgeniy S. Nimon, Danville, CA (US); Steven J. Visco, Berkeley, CA (US); Philip N. Ross, JR., Moraga, CA (US)

(73) Assignee: POLYPLUS BATTERY COMPANY, Berkeley, CA (US)

(21) Appl. No.: 13/080,170

(22) Filed: Apr. 5, 2011

Related U.S. Application Data
(62) Division of application No. 11/354,223, filed on Feb. 13, 2006, now abandoned.
(60) Provisional application No. 60/653,248, filed on Feb. 14, 2005.

(51) Int. Cl. H01M 10/04; H01M 4/04

(52) U.S. Cl. 29/623.1; 205/59

(57) ABSTRACT

Battery cells having lithium intercalation anodes protected by surface coatings and active sulfur cathodes, and methods for their fabrication, provide improved battery cell performance.

### CROSS-REFERENCE TO RELATED APPLICATIONS

This application is a divisional of prior application Ser. No. 11/354,223 filed on Feb. 13, 2006, titled INTERCALATION ANODE PROTECTION FOR CELLS WITH DISSOLVED LITHIUM POLYSULFIDES, which claims priority from U.S. Provisional Application No. 60/653,248 filed Feb. 14, 2005, titled INTERCALATION ANODE PROTECTION FOR CELLS WITH DISSOLVED LITHIUM POLYSULFIDES, the disclosures of which are incorporated by reference herein in their entirety for all purposes.

### BACKGROUND OF THE INVENTION

The present invention relates to battery cells having active metal (e.g., lithium) intercalation anodes and active sulfur-based cathodes and methods for their fabrication.

The use of a negative electrode based on lithium-carbon intercalation compounds in battery cells with active sulfur cathodes would provide a high energy density battery free of the safety and performance challenges sometimes associated with lithium metal anode battery cells. Also, since the cost of raw materials (primarily carbon and sulfur) for such a battery should be quite low they would be particularly well-suited to applications like electric vehicles and hybrid electric vehicles, where the cost of the battery is a critical factor in commercial viability. However, the surface of such an anode would need to be modified such that it allows for Li ion intercalation/de-intercalation into/from the intercalation material. Also, the anode surface layer must be able to passivate (i.e., substantially reduce or eliminate) the electrochemical redox reactions of polysulfides on the carbon surface.

Thus, a battery cells having an appropriate active metal (e.g., lithium) intercalation anode structure and active sulfur-based cathode, and methods for their fabrication are needed.

### SUMMARY OF THE INVENTION

The present invention addresses this need by providing battery cells having protected lithium intercalation anodes and sulfur- or lithium polysulfide-based cathodes and methods for their fabrication. The battery cells include a lithium intercalation negative electrode, an active sulfur-based positive electrode, and a liquid electrolyte. The surface of the negative electrode is modified and protected with a surface coating that passivates redox reactions of polysulfides on the negative electrode and allows for lithium intercalation/de-intercalation into/from the negative electrode. The surface modification (e.g., layer) functions as a protective coating.

The battery cells may be made according to several different techniques

These and other features of the invention will be further described and exemplified in the drawings and detailed description below.

### BRIEF DESCRIPTION OF THE DRAWINGS

FIG. 1 illustrates a battery cell in accordance with the present invention.

FIGS. 2, 3 and 4 illustrate alternative fabrications techniques in accordance with the present invention.

FIG. 5 shows a plot of the cycling performance of a treated carbon anode in a cell in accordance with the present invention.

FIG. 6 shows a plot of the typical voltage profile for a pretreated (lithiated and protected) carbon anode during its cycling in the 5 MS catholyte in a cell in accordance with the present invention.

### DETAILED DESCRIPTION OF SPECIFIC EMBODIMENTS

In the following description, the invention is presented in terms of certain specific compositions, configurations, and processes to help explain how it may be practiced. The invention is not limited to these specific embodiments. For example, while much of the following discussion focuses on lithium systems, the invention pertains more broadly to the class of active metal battery systems (e.g., batteries having negative electrodes of alkali and alkaline earth metals). Examples of specific embodiments of the invention are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the scope and equivalents of the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Introduction

The present invention provides battery cells having protected lithium intercalation anodes and sulfur- or lithium polysulfide-based cathodes and methods for their fabrication. The battery cells include a lithium intercalation negative electrode, an active sulfur-based positive electrode, and a liquid electrolyte. The surface of the negative electrode is modified and protected with a surface coating that passivates redox reactions of polysulfides on the negative electrode and allows for lithium intercalation/de-intercalation into/from the negative electrode. When the liquid electrolyte contains dissolved active sulfur cathode material in the form of polysulfides it is called a catholyte. The surface modification (e.g., layer) functions as a protective anode coating. While the invention is not limited by any particular theory, the surface modification is believed to be a film covering the entire exposed surface area of the individual particles of intercalation material in the anode coating.

For clarity of presentation, the invention is described herein primarily with reference to Li-based anodes. However, it should be understood that suitable anodes may be composed of other active metals and alloys as described herein, and the protective films or reagents described as containing Li may correspondingly contain such other active metals or alloys.

Active metals are highly reactive in ambient conditions and can benefit from a barrier layer when used as electrodes. They are generally alkali metals such (e.g., lithium, sodium or potassium), alkaline earth metals (e.g., calcium or magnesium), and/or certain transitional metals (e.g., zinc), and/or alloys of two or more of these. The following active metals may be used: alkali metals (e.g., Li, Na, K), alkaline earth metals (e.g., Ca, Mg, Ba), or binary or ternary alkali metal alloys with Ca, Mg, Sn, Ag, Zn, Bi, Al, Cd, Ga, In. Preferred alloys include lithium aluminum alloys, lithium silicon alloys, lithium tin alloys, lithium silver alloys, and sodium lead alloys (e.g., Na₄Pb). A preferred active metal electrode is composed of lithium.

Battery Cells

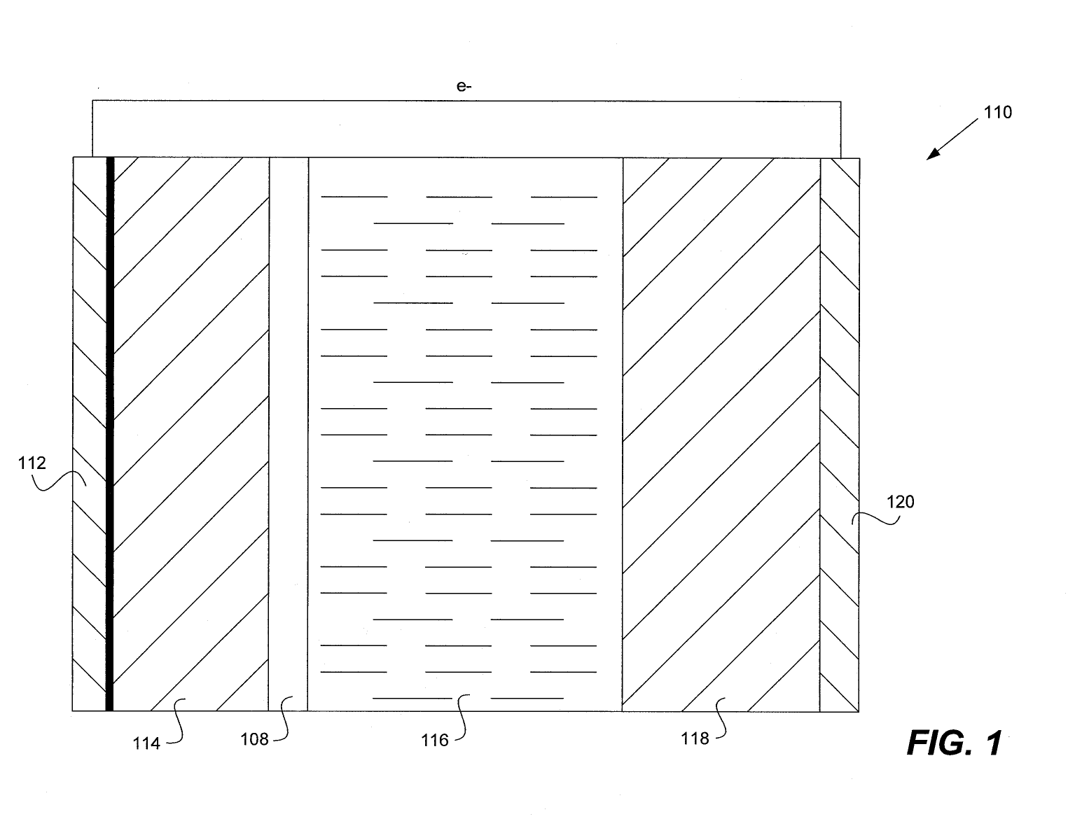

Referring now to FIG. 1, a cell 110 in accordance with a preferred embodiment of the present invention is shown. Cell 110 includes a negative current collector 112 which is formed of an electronically conductive material. The current collector serves to conduct electrons between a cell terminal (not shown) and a negative electrode 114 to which current collector 112 is affixed. The negative electrode 114 is a lithium intercalation material and includes a protective surface layer 108 formed opposite current collector 112. The protective layer 108 is in direct contact with an electrolyte compartment 116 containing a separator layer filled with an electrolyte (catholyte).

A separator prevents electronic contact between the positive and negative electrodes. A positive electrode 118 abuts the side of separator layer 116 opposite negative electrode 114. Since electrolyte in compartment 116 is an electronic insulator and an ionic conductor, positive electrode 118 is ionically coupled to but electronically insulated from negative electrode 114. Finally, the side of positive electrode 118 opposite electrolyte region 116 is affixed to a positive current collector 120. Current collector 120 provides an electronic connection between a positive cell terminal (not shown) and positive electrode 118.

The current collector 120, which provides the current connection to the positive electrode, should resist degradation in the electrochemical environment of the cell and should remain substantially unchanged during discharge and charge. In one embodiment, the current collectors are sheets of conductive material such as aluminum or stainless steel. The positive electrode may be attached to the current collector by directly forming it on the current collector or by pressing a pre-formed electrode onto the current collector. Positive electrode mixtures formed directly onto current collectors preferably have good adhesion. Positive electrode films can also be cast or pressed onto expanded metal sheets. Alternately, metal leads can be attached to the positive electrode by crimp-sealing, metal spraying, sputtering or other techniques known to those skilled in the art. Some positive electrode can be pressed together with the electrolyte separator sandwiched between the electrodes. In order to provide good electrical conductivity between the positive electrode and a metal container, an electronically conductive matrix of, for example, carbon or aluminum powders or fibers or metal mesh may be used.

The separator may occupy all or some part of electrolyte compartment 116. Preferably, it will be a highly porous/permeable material such as a felt, paper, or microporous plastic film. It should also resist attack by the electrolyte and other cell components. Examples of suitable separators include glass, plastic, ceramic, and porous membranes thereof among other separators known to those in the art. In one specific embodiment, the separator is Celgard 2400 available from Celgard, LLC.

The negative electrode 114 has a protective coating 108 that passivates redox reactions of the polysulfides on the electrode surface. Passivation means that the protective layer prevents or greatly reduces the rate of redox reactions of polysulfide species, such that in the fully charged state, the battery capacity loss is less than 50% after storage for 24 hours, preferably less than 10%, more preferably less than 5%, and even more preferably less than 1% after storage for 24 hours. The anode protective layer may be composed of phosphorus- or sulfur-based compounds. It has previously been found that during the first charge of a carbon electrode in a propylene chloride-based electrolyte containing an additive of ethylene sulfite, a surface film containing such inorganic and organic sulfur compounds as lithium sulfite and ROSO₂Li was formed on the electrode surface. This film greatly improved stability of the solid electrolyte interface on the electrode surface. In a preferred embodiment of the current invention where ethylene sulfite is used as a precursor material for protection of lithium-carbon intercalation material, the protective layer comprises sulfur-based compounds.

The negative electrode comprises carbon as described by the formula LiₓC where x=0 for the unlithiated carbon and x ranges from 0 to ⅓^{rd} with x=⅙^{th} for the case of fully intercalated graphite (LiC₆). All types of the carbon-based intercalation materials developed and used as negative electrodes of lithium-ion batteries can be also used in the current invention as negative electrode intercalation materials. Such materials are described in many publications, in particular in Chapter Thirty Five of The Handbook of Batteries, Third Edition, Editors D. Linden and T. Reddy. The suitable carbon materials may include petroleum coke, graphitic materials, and materials employing graphitic spheres, in particular, a mesocarbon microbead (MCMB) carbon. Also, in some of the embodiments highly disorganized hard carbon materials offering higher lithium intercalation capacity than that of carbon can be used.

In various embodiments, the positive active sulfur electrode may be composed of elemental sulfur, lithium sulfide or lithium polysulfides. The lithium sulfide or lithium polysulfide of the cathode generally has the formula Li₂Sₙ, where n is from 1 to 20, preferably from 1 to 8, even more preferably from 1 to 2 (lower numbers in the discharged state). Additional details of suitable positive electrodes for cells in accordance with the present invention are described in U.S. Pat. No. 6,376,123, which is incorporated by reference herein in its entirety and for all purposes.

In some embodiments the electrolyte can keep dissolved active sulfur cathode materials in the form of polysulfides away from the anode surface, for instance by greatly suppressing solubility of lithium polysulfides. Such an electrolyte comprises a single organic aprotic solvent or a mixture of two or more such solvents with a low solubility of polysulfides. The electrolyte also contains a supporting lithium salt to enhance the conductivity of the electrolyte. In other embodiments the electrolyte contains dissolved cathode active material in the form of lithium polysulfides. As mentioned above, such electrolyte is called a catholyte. The catholyte comprises a solvent that maintains polysulfides in solution and available for electrochemical reaction. The solvent is typically an ether, preferably a glyme or related compound. A particularly preferred example is 1,2-dimethoxyethane (DME) or monoglyme. Such solvents have high solubility of lithium polysulfides. Suitable liquid electrolyte solvents are described in more detail in U.S. Pat. No. 6,376,123, previously incorporated by reference, and include, for example, sulfolane, dimethyl sulfone, dialkyl carbonates, tetrahydrofuran (THF), dioxolane, propylene carbonate (PC), ethylene carbonate (EC), dimethyl carbonate (DMC), butyrolactone, N-methylpyrrolidinone, tetramethylurea, glymes, ethers, crown ethers, dimethoxyethane (DME), and combinations of such liquids.

The catholyte may also contain one or more co-solvents to enhance catholyte conductivity and its compatibility with electrode materials. Examples of such additional cosolvents include sulfolane, dimethyl sulfone, tetrahydrofuran (THF), dioxolane, alkyl carbonates such as propylene carbonate (PC), ethylene carbonate (EC), dimethyl carbonate (DMC), and also butyrolactone, N-methylpyrrolidinone, hexamethylphosphoramide, pyridine, N,N-diethylacetamide, N,N-diethylformamide, dimethylsulfoxide, tetramethylurea, N,N-dimethylacetamide, N,N-dimethylformamide, tributylphosphate, trimethylphosphate, N,N,N′,N′-tetraethylsulfamide, tetraethylenediamine, tetramethylpropylenediamine, pentamethyldiethylenetriamine, nitromethane, trifluoroacetic acid, trifluoromethanesulfonic acid, sulfur dioxide, boron trifluoride, and combinations of such liquids. A particularly preferred example is dioxolane.

U.S. Pat. No. 6,376,123, previously incorporated by reference herein, describes other aspects of battery cells that may be suitable in accordance with the present invention.

The battery cells of this invention are rechargeable “secondary” cells. Unlike primary cells which discharge only once, the secondary cells of this invention cycle between discharge and charge at least two times. Typically, secondary cells of this invention will cycle at least 50 times.

Methods

The battery cell, and the associated protected anode, may be formed in a number of ways. The anode may be protected and/or lithiated in situ or ex situ. In the in situ case, a battery is assembled from battery elements including an intercalation negative electrode, electrolyte and a positive electrode. The intercalation anode is then lithiated by an initial charging operation in which lithium intercalates into the anode intercalation material, typically carbon. Alternatively, the anode may be chemically lithiated, but unprotected, prior to being placed in the battery cell. During the initial charge (or several charges), a protective coating is formed on the anode surface as a result of a reaction of a precursor, such as ethylene sulfite, on the anode surface. In the ex situ case, the electrode is formed in an electrochemical cell (formation cell) that is separate from the battery cell in which it is ultimately assembled. Thereafter the electrode is removed from the formation cell and assembled into a battery cell.

In Situ Electrochemical Lithiation and Protection of Anode

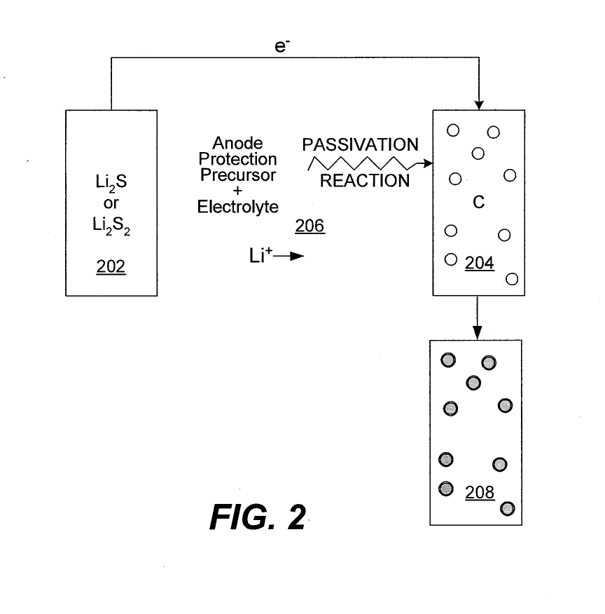

In one instance, the battery cell is formed by a technique in which the lithiation process and protection of the anode occur in situ. According to this technique, illustrated in FIG. 2, a battery cell having a protected lithium intercalation anode is made by providing in the cell reduced active sulfur in the form of a lithium sulfide (Li₂S) or lithium polysulfides (Li₂Sₙ) as a cathode material 202, an intercalation anode free of lithium 204, e.g., carbon, and an electrolyte 206 without dissolved polysulfides or a catholyte having a solvent, such as a glyme, e.g., DME (and optionally a co-solvent, such as dioxolane) that maintains polysulfides in solution and available for electrochemical reaction. The supporting salt dissolved in the above-mentioned solvent or a mixture of solvents can be one of LiPF₆, LiBF₄, LiAsF₆, LiClO₄, LiSO₃CF₃, LiN(CF₃SO₂)₂ (LiTFSI), LiN(SO₂C₂F₅)₂ and combinations thereof and serves to enhance the solution conductivity. The electrolyte or catholyte also comprises a precursor (e.g., ethylene sulfite (ES)) for modification of the electrode surface and formation of a protective coating. The cell is then charged. Charging leads to intercalation of lithium into the anode and formation of a lithium-carbon intercalation material. The cathode material (Li₂S or Li₂Sₙ polysulfides) acts as a source of Li ions for lithium intercalation into the carbon anode. During the first anode charge (or several charges) the precursor reacts on the anode surface forming the protective coating that passivates redox reactions of polysulfides on the anode intercalation material, and at the same time allows for lithium intercalation/de-intercalation into/from the anode.

The catholyte includes a main solvent, usually from a glyme family, in particular 1,2-dimethoxyethane (DME) or monoglyme, that maintains polysulfides in solution and makes them available for electrochemical reaction. The catholyte may also contain one or more co-solvents to enhance its conductivity and compatibility with anode material and also to increase the solubility of polysulfides. Examples of such additional cosolvents include sulfolane, dimethyl sulfone, tetrahydrofuran (THF), dioxolane, alkyl carbonates in particular propylene carbonate (PC), ethylene carbonate (EC), dimethyl carbonate (DMC); and also butyrolactone, N-methylpyrrolidinone, hexamethylphosphoramide, pyridine, N,N-diethylacetamide, N,N-diethylformamide, dimethylsulfoxide, tetramethylurea, N,N-dimethylacetamide, N,N-dimethylformamide, tributylphosphate, trimethylphosphate, N,N,N′,N′-tetraethylsulfamide, tetraethylenediamine, tetramethylpropylenediamine, pentamethyldiethylenetriamine, nitromethane, trifluoroacetic acid, trifluoromethanesulfonic acid, sulfur dioxide, boron trifluoride, and combinations of such liquids. A particularly preferred example is dioxolane.

The precursor for anode protection can be any compound that will react (chemically or electrochemically) on the surface of anode intercalation material and modify the surface forming a protective coating that passivates redox reactions of the polysulfides on the surface of anode, and at the same time allows for lithium intercalation/de-intercalation into/from the anode. Examples include ethylene sulfite, ethylene trithiocarbonate, thiophene, and thiophene-2-thiol, or H₃PO₄, HPO₃, LiH₂PO₄, Li₂HPO₄ and NR₄H₂PO₄, dibenzyl phosphate or other organic phosphates and mixtures thereof. Suitable concentrations of the precursor may range from about 0.5 to 50% by volume; preferably about 5 to 10%; for example about 5%. Ethylene sulfite is particularly preferred.

The cell charging that results in lithium intercalation into the anode also leads to oxidation of the cathode species, Li₂Sₙ (n increases). Usually, higher oxidized species, for example Li₂S₈, have greater solubility than less oxidized species, for example Li₂S₂. The solubility of the more highly oxidized polysulfides may produce a catholyte that has a sufficient conductivity even without addition of an electrolyte salt.

In the case of the electrolyte without dissolved polysulfides or when polysulfides are highly reduced and have low solubility, the protective layer can be formed and the surface modified by reaction of the precursor on the surface of the anode intercalation material before a substantial amount of more oxidized polysulfides enters the solution.

After formation of the lithium-carbon intercalation compound and its surface protection 208 the charged battery cell may be discharged. During discharge, the negative electrode (lithated intercalation anode) oxidizes, and de-intercalation of lithium ions from the lithium intercalation compound takes place. The highly oxidized polysulfides or sulfur are reduced on the surface of the cathode current collector. As a result, the polysulfide species decrease their oxidation state.

Subsequent charge/discharge cycles convert the negative electrode between a charged state in which lithium intercalated compound forms and a discharged state in which some or all of the intercalated lithium is de-intercalated (extracted). That same cycling converts the cathode and/or catholyte active material between charged state in which oxidizing species, such as elemental sulfur or Li₂S₈ form and discharged state in which more reduced species, which are less soluble or practically insoluble, form.

In Situ Protection of Chemically Lithiated Anode

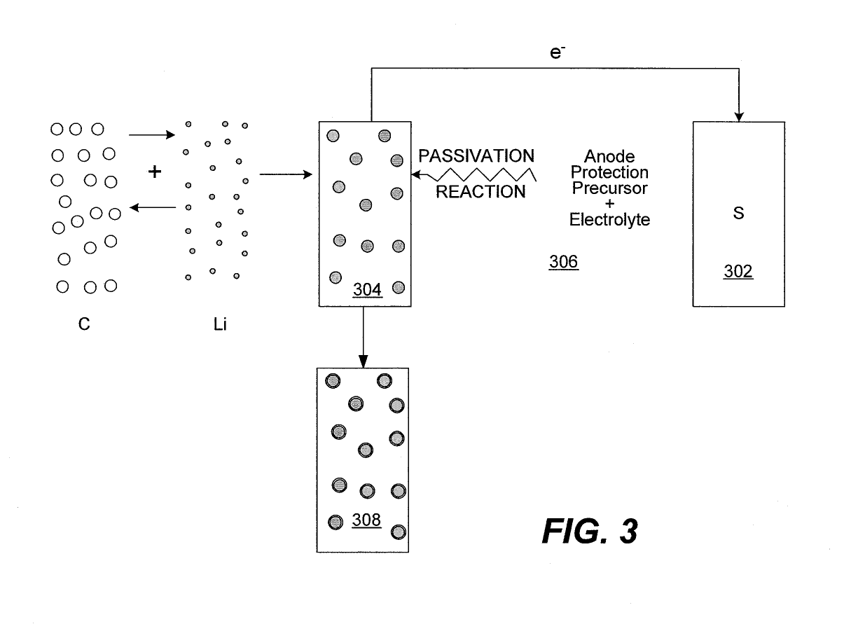

In another instance, the battery is formed by a technique in which the lithiation of the anode occurs chemically prior to placement of the anode into the battery cell, and anode protection occurs in situ. According to this technique, illustrated in FIG. 3, a battery cell having a protected lithium intercalation anode is made by providing in the cell an elemental sulfur or polysulfide-based cathode 302, a lithiated lithium intercalation anode, LiₓC 304, where 0.3>x>0, and an electrolyte. In a particularly important embodiment where the polysulfide species are dissolved in the solution, a catholyte contains a solvent, such as a glyme, e.g., DME and optionally a co-solvent, such as dioxolane, that maintains polysulfides in solution and makes them available for electrochemical reaction. The electrolyte (catholyte) has a precursor (e.g., ethylene sulfite (ES)) for modification of the surface of the lithium intercalation compound and formation of a protective coating that passivates redox reactions of the polysulfides on the anode intercalation material, and allows for lithium intercalation/de-intercalation into/from the anode.

The anode in this approach is chemically lithiated by direct reaction of the intercalation material free of lithium, e.g., carbon (C) with lithium metal (Li) outside the cell to form LiₓC where 0.3>x>0. This may be done by pressing together particulate carbon and particulate lithium (e.g., Lectro Max Powder available from FMC) to form a lithium-carbon compound. One such technique that may be used is that described in “Prelithiated Carbon Anode for Lithium-Ion Battery Applications using Electrode Microlithiation Technology (EMT),” Gao et al, Abstract 317, 206^{th} Meeting of the Electrochemical Society, incorporated by reference herein in its entirety and for all purposes. The lithiated but unprotected anode 304 is then placed in the cell with the other battery components noted above.

In the cell, the lithiated carbon is exposed to the precursor (e.g., ethylene sulfite) dissolved in the electrolyte 306 and allowed sufficient time to form the protective coating on the chemically lithiated negative electrode 308 prior to cell discharge. In some cases, in order to form a protective coating, the negative electrode needs to be additionally charged prior to cell discharge. Again, the protective coating forms by reaction of the precursor on the surface of the intercalation material of the anode prior to a substantial amount of polysulfides entering the solution.

The other aspects of the battery are as described above for the first in situ case. In particular, the catholyte includes a solvent that maintains polysulfides in solution and available for electrochemical reaction, such as an ether, particularly from the glyme family (liner polyethers), for example 1,2-dimethoxyethane (DME) or monoglyme. The catholyte may also contain one or more co-solvents to enhance conductivity and compatibility with anode material and also to increase polysulfide solubility. Examples of such additional cosolvents include sulfolane, dimethyl sulfone, tetrahydrofuran (THF), dioxolane, alkyl carbonates in particular propylene carbonate (PC), ethylene carbonate (EC), dimethyl carbonate (DMC), and also butyrolactone, N-methylpyrrolidinone, hexamethylphosphoramide, pyridine, N,N-diethylacetamide, N,N-diethylformamide, dimethylsulfoxide, tetramethylurea, N,N-dimethylacetamide, N,N-dimethylformamide, tributylphosphate, trimethylphosphate, N,N,N′,N′-tetraethylsulfamide, tetraethylenediamine, tetramethylpropylenediamine, pentamethyldiethylenetriamine, nitromethane, trifluoroacetic acid, trifluoromethanesulfonic acid, sulfur dioxide, boron trifluoride, and combinations of such liquids. A particularly preferred example is dioxolane.

Also, the anode protective layer precursor can be any compound that will react on the surface of anode intercalation material modifying its surface such that it passivates redox reactions of the polysulfides on the surface of anode, and allows for lithium intercalation/de-intercalation into/from the anode. Examples include ethylene sulfite, ethylene trithiocarbonate, thiophene, and thiophene-2-thiol, or H₃PO₄, HPO₃, LiH₂PO₄, Li₂HPO₄ and NR₄H₂PO₄, dibenzyl phosphate or other organic phosphates and mixtures thereof. Suitable concentrations of the precursor may range from about 0.5 to 50% by volume; preferably about 5 to 10%; for example about 5%. Ethylene sulfite is particularly preferred.

Ex Situ Electrochemical Lithiation and Protection of Anode

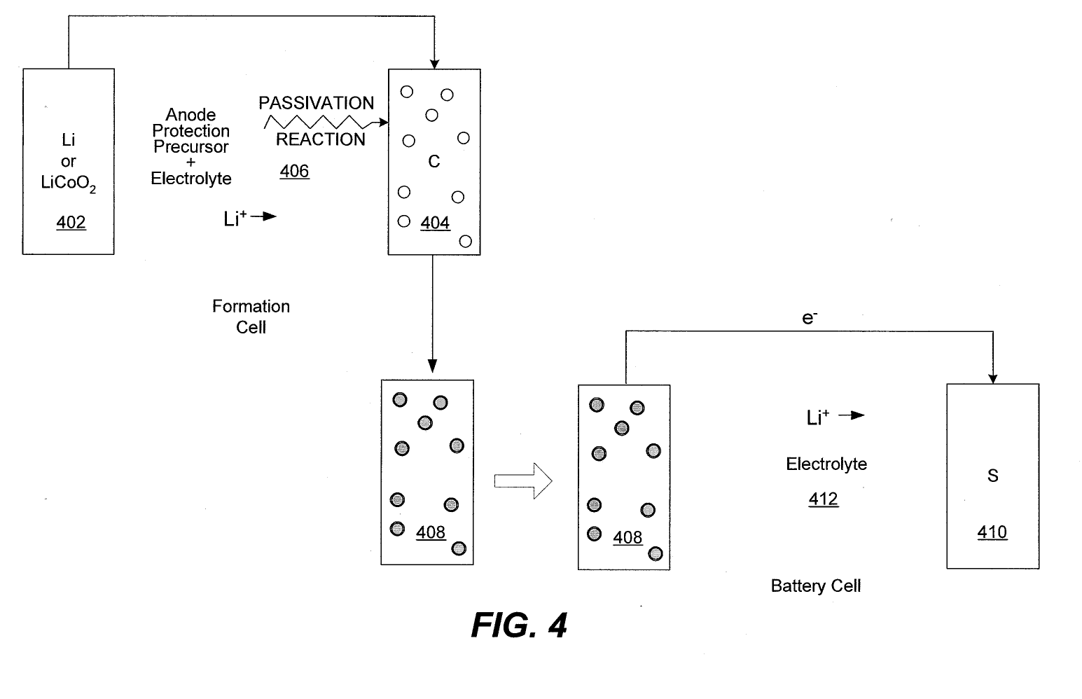

In the ex situ case, the electrode is formed in an electrochemical formation cell that is separate from the battery in which it is ultimately assembled. In this instance, the battery is formed by a technique in which the lithiation and protection of the anode occurs ex situ. According to this technique, illustrated in FIG. 4, a battery cell having a protected lithium intercalation anode (LiₓC where 0.3>x>0) 408 is made by forming a lithiated and protected anode by electrochemical lithiation in a cell that is separate from the final battery or cell in which the electrode is used. The cell for ex situ lithiation (the formation cell) contains an uncharged (free of lithium) intercalation anode 404 (e.g. carbon), a non-aqueous electrolyte 406 comprising a precursor for formation of a protective coating on the anode surface, and a source of lithium in the cell for the anode lithiation such as an electrode comprising lithium metal or a lithiated metal oxide or phosphate typically used as cathode materials in lithium ion batteries (e.g., LiCoO₂, LiNiO₂, LiMn₂O₄, mixed Ni—Co lithium oxides, and LiFePO₄) 402.

The electrolyte 406 of the formation cell preferably includes an aprotic organic solvent compatible with the anode and the cathode of the formation cell and an electrolyte salt, such as LiPF₆, typically used in the electrolytes of lithium-ion cells. Suitable electrolytes are based on alkyl carbonate solutions including mixtures of ethylene carbonate and propylene carbonate with linear carbonates in particular dimethyl carbonate, diethyl carbonate, ethyl methyl carbonate and others or with low viscosity solvents such as some ethers (DME, THF) or methyl acetate and methyl formate. Other suitable electrolytes may be based on propylene carbonate as an individual solvent. In order to avoid exfoliation of the carbon anode and irreversible degradation during lithium intercalation, a precursor for formation of a protective coating on the anode surface, as described above, is added to the electrolyte. A preferred additive, found to significantly improving stability of the carbon/propylene carbonate interface, is ethylene sulfite.

In addition to the solvent (or the mixture of solvents) and the supporting salt, the electrolyte of the formation cell contains a precursor that can be any compound that will react on the surface of the anode intercalation material to form a coating that passivates redox reactions of the polysulfides on the surface of anode in the battery cell containing sulfur or polysulfide based cathode and also allows for lithium intercalation/de-intercalation into/from the anode in such a cell. Examples include ethylene sulfite, ethylene trithiocarbonate, thiophene, and thiophene-2-thiol, or H₃PO₄, HPO₃, LiH₂PO₄, Li₂HPO₄ and NR₄H₂PO₄, dibenzyl phosphate or other organic phosphates and mixtures thereof. Suitable concentrations of the precursor may range from about 0.5 to 50% by volume; preferably about 5 to 10%; for example about 5%. Ethylene sulfite is particularly preferred.

During the electrode formation operation, the anode charges and Li⁺ ions from the electrolyte (catholyte) intercalate into the carbon forming lithium-carbon intercalation material. Several different charging protocols similar to the charging protocols used for lithium-ion cells can be used. One of them is charge at a constant current (or sequentially at several currents) until the anode potential reaches a set value. The second commonly used charging protocol includes charging at a constant current followed by charging at a constant potential. During the anode charging, the precursor, e.g., ethylene sulfite, also reacts on the surface of the anode intercalation material (in particular, participating in the electrochemical reduction process) and forms the protective coating.

Accordingly, a method of making a protected lithium intercalation anode 408 for a battery cell according to the invention involves providing in an anode formation cell, a cathode having a source of lithium for lithium intercalation into the anode (e.g., lithium metal or above-mentioned lithiated oxides or phosphates commonly used as cathode materials of lithium ion batteries), an anode having a lithium intercalation material, an electrolyte comprising a lithium salt dissolved in an aprotic organic solvent and a precursor for formation of a protective coating on the surface of the lithium intercalation compound. The cell is then charged and the anode is lithiated by intercalation of Li⁺ ions from the electrolyte (catholyte) into the carbon forming lithium-carbon intercalation compound LiₓC where 0.3>x>0. During anode charging the precursor reacts at the anode surface forming the protective coating. In some cases, in order to achieve a better protection more than one formation cycle is required, and the formation process includes several discharge/charge cycles with charge being the last half cycle. After transfer into the battery cell an anode can be additionally pre-cycled in order to improve the protective properties of the surface coating.

After formation (lithiation and protection) is complete, the protected anode 408 is removed from the electrochemical formation cell and assembled into a battery cell with an active sulfur-based (e.g., elemental sulfur) cathode 410 and a suitable electrolyte 412. The battery cell is available for immediate discharge since the protective coating is formed. Thus, the ex situ method involves electrochemically lithiating and treating a negative electrode intercalation material to form a lithiated anode having a protective coating that passivates redox reactions of polysulfides on the anode surface and allows for lithium intercalation/de-intercalation into/from the negative electrode.

In one embodiment the battery cell electrolyte 412 comprises an aprotic organic solvent or a mixture of two or more such solvents, a lithium supporting salt and does not comprise dissolved lithium polysulfides. In other embodiment the dissolved polysulfides are present in the liquid electrolyte (catholyte). The battery cell catholyte includes a solvent that maintains polysulfides in solution and available for electrochemical reaction, such as an ether, particularly a glyme, for example 1,2-dimethoxyethane (DME; also referred to as monoglyme). The catholyte may also contain one or more co-solvents to enhance conductivity and compatibility with anode material and also to increase polysulfides solubility. Examples of such additional cosolvents include sulfolane, dimethyl sulfone, alkyl carbonates such as propylene carbonate (PC), ethylene carbonate (EC), dimethyl carbonate (DMC) and others, and also tetrahydrofuran (THF), dioxolane, butyrolactone, N-methylpyrrolidinone, hexamethylphosphoramide, pyridine, N,N-diethylacetamide, N,N-diethylformamide, dimethylsulfoxide, tetramethylurea, N,N-dimethylacetamide, N,N-dimethylformamide, tributylphosphate, trimethylphosphate, N,N,N′,N′-tetraethylsulfamide, tetraethylenediamine, tetramethylpropylenediamine, pentamethyldiethylenetriamine, nitromethane, trifluoroacetic acid, trifluoromethanesulfonic acid, sulfur dioxide, boron trifluoride, and combinations of such liquids. A particularly preferred example is dioxolane.

### Examples

The following examples provide details illustrating advantageous properties of protected lithium intercalation anode/polysulfide battery cells in accordance with the present invention. These examples are provided to exemplify and more clearly illustrate aspects of the present invention and are in no way intended to be limiting.

An ex situ method of carbon anode surface treatment was used to form a charged (lithiated), protected carbon anode with surface stability to lithium polysulfides.

A standard carbon anode (70 micrometers in thickness) developed for Li-ion batteries and based on mesocarbon microbead carbon was equipped with a stainless steel current collector. The anode was cycled three times in a formation cell, with the last half cycle being a charge, in an electrolyte solution composed of 1 M LiPF₆ in propylene carbonate and containing 5% by volume of ethylene sulfite. The current density used for the treatment was 0.3 mA/cm². The charge capacity was 2.9 mAh/cm².

The treated and charged (lithiated) carbon anode was removed from the formation cell and placed in a battery cell with a catholyte containing 5M S as Li₂S₈ dissolved in the mixture of DME and Dioxolane (9:1) with addition of 0.5 M of LiTFSI supporting salt and with a porous carbon cathode based on carbon paper CP-035.

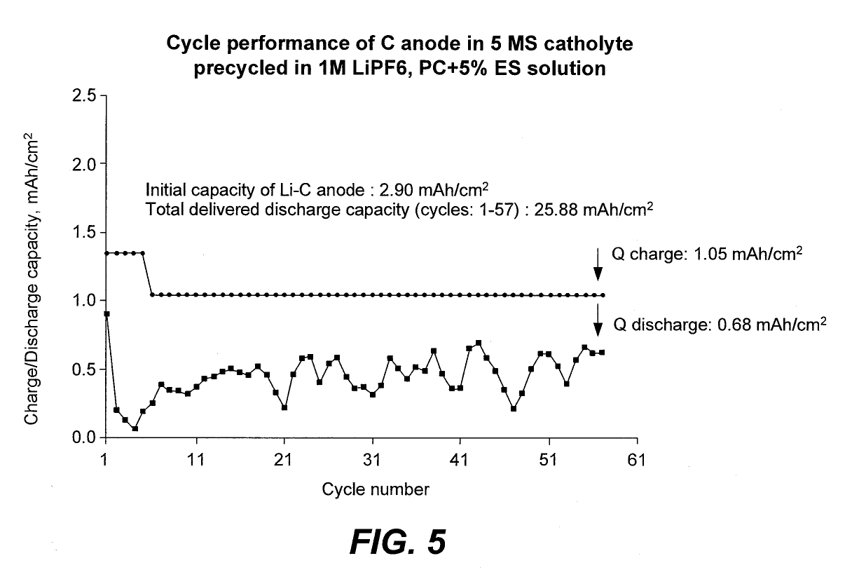

FIG. 5 illustrates the cycling performance of the treated carbon anode in the cell over 57 cycles. The following cycling protocol was used. Both charge and discharge current densities were 0.3 mA/cm². During the first five cycles the cell was charged for 4.5 hours. During further cycling charging for 3.5 hours was used. The discharge cutoff voltage was 1.25 V. As can be seen in the figure, there is no discharge capacity fade on cycling. On the contrary, the capacity gradually increases.

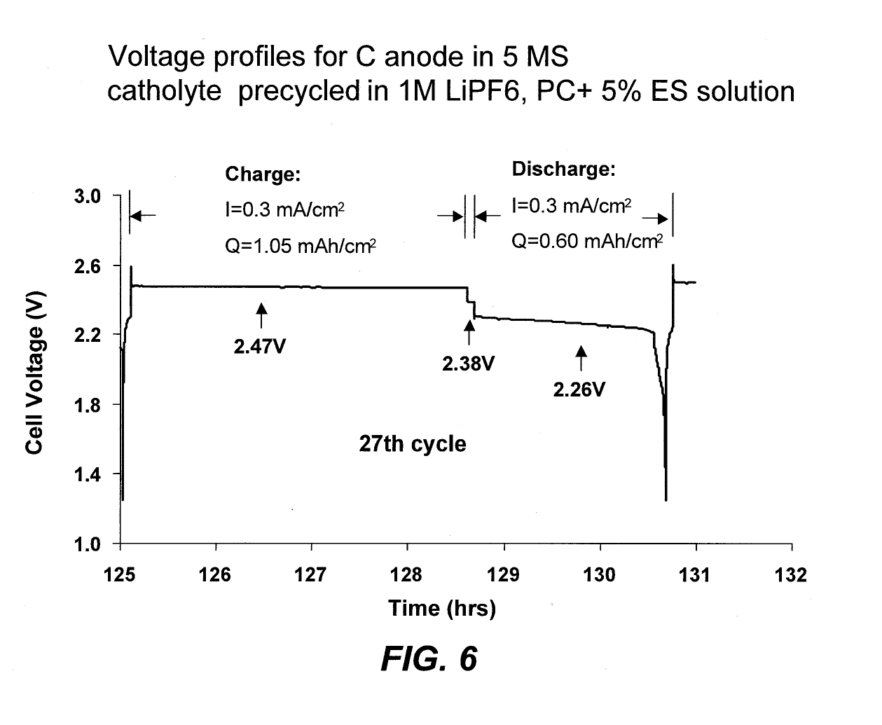

FIG. 6 shows the typical voltage profile for a pretreated (lithiated and protected) carbon anode during its cycling in the 5 MS catholyte. The discharge capacity is smaller than the charge capacity. This effect may be associated with incomplete protection of the carbon surface. An OCV value measured during the cell rest between the charge and discharge half cycles was always between 2.35 and 2.40 V. This value is close to the OCV of a Li-sulfur couple.

The initial charge capacity of 2.90 mAh/cm² corresponding to the amount of Li intercalated into the carbon was almost one order of magnitude smaller than the total delivered discharge capacity of 25.9 mAh/cm². This demonstrates that precycling of the carbon anode in the electrolyte containing ethylene sulfite (ES) protects the carbon anode surface and it behaves as an intercalation anode in solutions containing lithium polysulfides. In this case lithium polysulfides act as a source of Li ions during lithium intercalation into the carbon anode.

These results provide the first known opportunity to combine a lithiated carbon intercalation anode with a liquid polysulfide cathode and develop a new type of high-energy rechargeable battery.

### CONCLUSION

Although the foregoing invention has been described in some detail for purposes of clarity of understanding, it will be apparent that certain changes and modifications may be practiced within the scope of the invention. While the invention has been described in conjunction with some specific embodiments, it will be understood that it is not intended to limit the invention to such specific embodiments. On the contrary, it is intended to cover alternatives, modifications, and equivalents as may be included within the spirit and scope of the invention as defined by the appended claims.

All references cited herein are incorporated by reference for all purposes.

What is claimed:

1.-43. (canceled)

44. A method of making a battery cell having a protected lithium intercalation anode, comprising:
electrochemically lithiating and treating a negative electrode intercalation material to form a lithiated anode having a surface protective coating; and
providing the lithiated and protected anode in the battery cell having,
a cathode comprising active sulfur, and
a liquid non-aqueous electrolyte; and
wherein the protective coating passivates redox reactions of polysulfides on the anode intercalation material and allows for lithium intercalation/de-intercalation into/from the anode.

45. The method of claim 44, wherein the negative electrode intercalation material is lithiated in an anode formation reaction in a formation electrochemical cell by intercalation of lithium ions from a cathode acting as a lithium source via a liquid electrolyte comprising a lithium supporting salt in an aprotic solvent.

46. The method of claim 44, wherein the electrolyte further comprises the precursor for formation of the anode protective coating, and the lithium intercalation material of the anode is protected as a result of surface reaction of the precursor during an anode formation reaction.

47. The method of claim 44, wherein the lithiated and protected anode is removed from the anode formation cell prior to placement in the battery cell.

48. The method of claim 44, wherein the negative electrode intercalation material is carbon as described by LiₓC where 0.3>x>0.

49. The method of claim 44, wherein the electrolyte (catholyte) comprises a solvent that maintains polysulfides in solution and available for electrochemical reaction.

50. The method of claim 49, wherein the solvent is an ether.

51. The method of claim 50, wherein the solvent is a glyme.

52. The method of claim 51, wherein the solvent is 1,2-dimethoxyethane.

53. The method of claim 52, wherein the solvent mixture further comprises dioxolane.

54. The method of claim 44, wherein the precursor for formation of the anode protective coating is selected from the group consisting of ethylene sulfite, ethylene trithiocarbonate, thiophene, and thiophene-2-thiol, H₃PO₄, HPO₃, LiH₂PO₄, Li₂HPO₄ and NR₄H₂PO₄, dibenzyl phosphate, other organic phosphates and mixtures thereof.

55. The method of claim 44, wherein the precursor for formation of the anode protective coating is ethylene sulfite.

56. The method of claim 45, wherein the liquid electrolyte of the formation cell comprises lithium supporting salt dissolved in individual or mixed organic carbonates or in mixtures of organic carbonates with ethers, methyl acetate and methyl formate.

57. The method of claim 45, wherein the liquid electrolyte of the formation cell comprises LiPF₆ dissolved in propylene carbonate.

58. A method of making a protected lithium intercalation anode for a battery cell, comprising:
providing in an anode formation cell,
a cathode acting as a source of lithium,
an anode comprising a negative electrode intercalation material,
an electrolyte comprising a lithium supporting salt dissolved in an organic aprotic solvent or in a mixture of the organic aprotic solvents, and
a precursor for formation of a protective coating;
charging the cell, whereby the anode is lithiated by intercalation of lithium ions from the electrolyte, and the lithium intercalation material of the anode is protected from reactions with polysulfides by the surface coating formed as a result of surface reaction of the precursor during cell charging; and
removing the lithiated and protected anode from the formation cell and placing it in the battery cell.

59. The method of claim 58, wherein the source of lithium for the anode lithiation is an electrode comprising lithium metal or a lithiated metal oxide or phosphate.

60. The method of claim 58, wherein the electrolyte (catholyte) comprises a solvent that maintains polysulfides in solution and available for electrochemical reaction.
